(19) United States
(12) Patent Application Publication
(10) Pub. No.: US 2018/0052853 A1
(43) Pub. Date: Feb. 22, 2018

(54) ADJUSTING FEATURE WEIGHTS FOR RANKING ENTITY BASED SEARCH RESULTS

(71) Applicant: salesforce.com, inc., San Francisco, CA (US)

(72) Inventors: Scott Thurston Rickard, JR., Bellevue, WA (US); Clifford Z. Huang, Seattle, WA (US); J. Justin Donaldson, Seattle, WA (US)

(21) Appl. No.: 15/243,598

(22) Filed: Aug. 22, 2016

(51) Int. Cl. G06F 17/30

(52) U.S. Cl. CPC G06F 17/3053; G06F 17/30867; G06F 17/30312

(57) ABSTRACT

A system stores objects of different types and allows search over the objects. The system receives search requests and processes them to determine search results matching the search criteria. The system ranks the search results based on weighted aggregates of features describing objects represented by each search result. The system monitors search results that were accessed by user for further information and marks them as accessed results. The system adjusts the feature weights used for ranking search results to optimize the ranking of the search results. The system analyzes the result of using the adjusted feature weights on past searches that are stored in the system. The system determines an aggregate accessed results rank for each adjusted set of weights. The system selects a set of feature weights that optimizes the aggregate accessed results rank for past searches.

### BACKGROUND

### Field of Art

The disclosure relates to ranking of search results in general and in particular to adjusting feature weights used for ranking search results representing objects.

### Description of the Related Art

Systems used by enterprises, organizations, businesses store large amount of information associated with entities such as users, customers, documents, transactions, and so on. These systems allow users to perform searches for information. The search engines used for performing these searches are tuned so that they return search results that are likely to be of interest to the requestor. Tuning the search results requires access to the stored data. However, there is a growing trend for enterprises to use systems provided by third parties, for example, multi-tenant systems. A multi-tenant system stores data for multiple enterprises. Since, enterprises want to store their information securely, they may not provide the multi-tenant system with full access to the stored information. As a result, search engines maintained by such systems do not have access to all data that is typically used for tuning the search engine. If the search engine is not tuned properly, the search engine may return results that are not relevant to the search or rank the results poorly. Accordingly, conventional techniques for tuning search engines are often inadequate for systems that do not have full access to the underlying data, for example, multi-tenant systems.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 shows an overall system environment illustrating an online system receiving search requests from clients and processing them, in accordance with an embodiment.

FIG. 2 shows the system architecture of a search module, in accordance with an embodiment.

FIG. 3 shows the process of executing searches, in accordance with an embodiment.

FIG. 4 shows the process of determining feature weights for ranking search results, in accordance with an embodiment.

FIGS. 5A and 5B illustrate how ranking of search results may be improved by modifying feature weights, in accordance with an embodiment.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### DETAILED DESCRIPTION

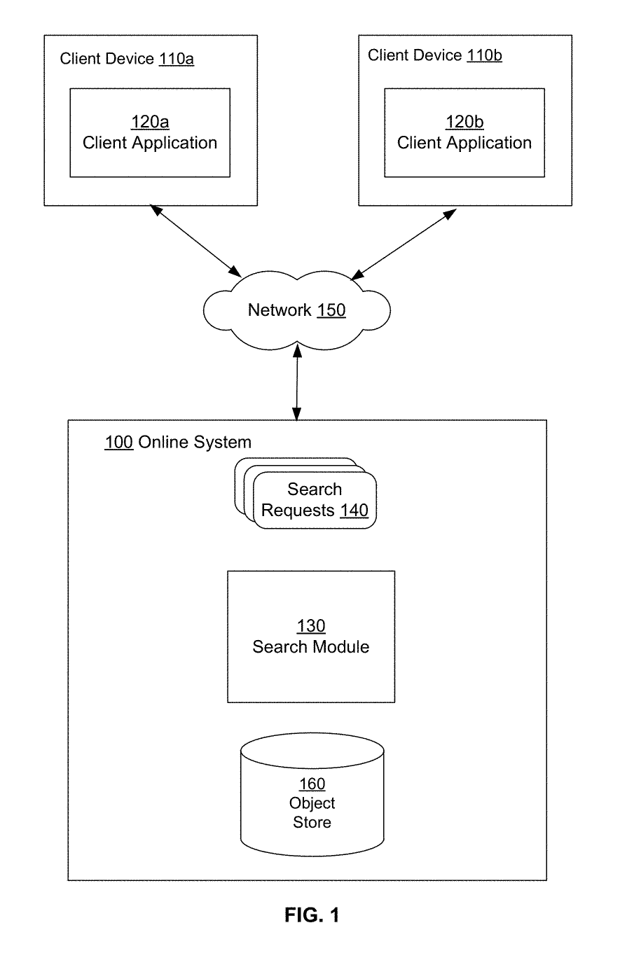

FIG. 1 shows an overall system environment illustrating an online system receiving search requests from clients and processing them, in accordance with an embodiment. The overall system environment includes an online system 100, one or more client devices 110, and a network 150. Other embodiments may use more or less or different systems than those illustrated in FIG. 1. Functions of various modules and systems described herein can be implemented by other modules and/or systems than those described herein.

FIG. 1 and the other figures use like reference numerals to identify like elements. A letter after a reference numeral, such as “120a,” indicates that the text refers specifically to the element having that particular reference numeral. A reference numeral in the text without a following letter, such as “120,” refers to any or all of the elements in the figures bearing that reference numeral (e.g. “120” in the text refers to reference numerals “120a” and/or “120b” in the figures).

A client device 110 is used by users to interact with the online system 100. A user interacts with the online system 100 using client application 120. An example of a client application 120 is a browser application. In an embodiment, the client application 120 interacts with the online system 100 using HTTP requests sent over network 150.

The online system 100 includes an object store 160 and a search module 130. The online system 100 receives search requests 140 from users via the client devices 110. The object store 160 stores data represented as objects. Each object represents an entity associated with an enterprise. A search request specifies certain search criteria. The search module 130 processes the search requests 140 and determines search results comprising objects that match the search criteria specified in the search request. The online system 100 ranks the search results based on a measure of likelihood that the user is interested in a search result. The online system 100 sends the ranked search results to the client device 110. The client device 110 presents the search results based on the ranking, for example, search in an order determined based on the ranking.

The search module 130 uses features extracted from objects represented by the search results to rank the search results. In an embodiment, the search module 130 determines a ranking score for each search result based on a weighted aggregate of the features describing the search result. Each feature is weighted based on a feature weight associated with the feature. The search module 130 adjusts the feature weights to improve the ranking of search results.

In an embodiment, the search module 130 modifies the feature weights and measures the impact of modifying the search result on ranking of past search requests. The online system stores information describing past search requests. The stored information comprises, for each stored search request, the search query and the set of search results returned in response to the search query. The online system 100 monitors which results were of interest to the user based on user interactions responsive to presenting the user with the search results. Accordingly, if the online system receives a data access request for an object represented by the search result, the online system 100 marks the search result as an accessed search result.

The search module 130 adjusts the feature weights to measure if the ranks of the accessed search results improve. Accordingly, the search module may try several different feature weight combinations and find a particular feature weight combination that results in the optimal ranking of accessed search results. The search module 130 determines that a ranking based on a first set of feature weights is better than a ranking based on a second set of feature weights if the accessed results are ranked higher on an average based on the first set of feature weights compared to the second set of feature weights.

In some embodiments, an online system 100 stores information of one or more tenants to form a multi-tenant system. Each tenant may be an enterprise as described herein. As an example, one tenant might be a company that employs a sales force where each salesperson uses a client device 110 to manage their sales process. Thus, a user might maintain contact data, leads data, customer follow-up data, performance data, goals and progress data, etc., all applicable to that user's personal sales process.

In one embodiment, online system 100 implements a web-based customer relationship management (CRM) system. For example, in one embodiment, the online system 100 includes application servers configured to implement and execute CRM software applications as well as provide related data, code, forms, webpages and other information to and from client devices 110 and to store to, and retrieve from, a database system related data, objects, and webpage content.

With a multi-tenant system, data for multiple tenants may be stored in the same physical database, however, tenant data typically is arranged so that data of one tenant is kept logically separate from that of other tenants so that one tenant does not have access to another tenant's data, unless such data is expressly shared. In certain embodiments, the online system 100 implements applications other than, or in addition to, a CRM application. For example, the online system 100 may provide tenant access to multiple hosted (standard and custom) applications, including a CRM application. According to one embodiment, the online system 100 is configured to provide webpages, forms, applications, data and media content to client devices 110 to support the access by client devices 110 as tenants of online system 100. As such, online system 100 provides security mechanisms to keep each tenant's data separate unless the data is shared.

A multi-tenant system may implement security protocols that keep data, applications, and application use separate for different tenants. In addition to user-specific data and tenant-specific data, the online system 100 may maintain system level data usable by multiple tenants or other data. Such system level data may include industry reports, news, postings, and the like that are sharable among tenants.

It is transparent to customers that their data may be stored in a table that is shared with data of other customers. A database table may store rows for a plurality of customers. Accordingly, in a multi-tenant system various elements of hardware and software of the system may be shared by one or more customers. For example, the online system 100 may execute an application server that simultaneously processes requests for a number of customers.

In an embodiment, the online system 100 optimizes the set of features weights for each tenant of a multi-tenant system. This is so because each tenant may have a different usage pattern for the search results. Accordingly, search results that are relevant for a first tenant may not be very relevant for a second tenant. Therefore, the online system determines a first set of feature weights for the first tenant and a second set of feature weights for a second tenant.

The online system 100 and client devices 110 shown in FIG. 1 can be executed using computing devices. A computing device can be a conventional computer system executing, for example, a Microsoft™ Windows™-compatible operating system (OS), Apple™ OS X, and/or a Linux distribution. A computing device can also be a client device having computer functionality, such as a personal digital assistant (PDA), mobile telephone, video game system, etc. The online system 100 stores the software modules storing instructions for embodiments, for example search module 130.

The interactions between the client devices 110 and the online system 100 are typically performed via a network 150, for example, via the Internet. In one embodiment, the network uses standard communications technologies and/or protocols. In another embodiment, the entities can use custom and/or dedicated data communications technologies instead of, or in addition to, the ones described above. The techniques disclosed herein can be used with any type of communication technology, so long as the communication technology supports receiving by the online system 100 of web requests from a sender, for example, a client device 110 and transmitting of results obtained by processing the web request to the sender.

### System Architecture

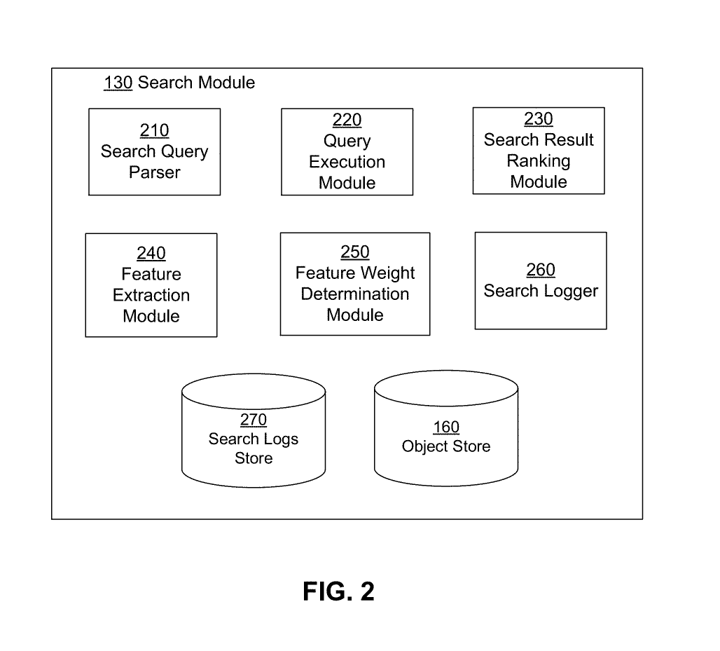

FIG. 2 shows the system architecture of a search module, in accordance with an embodiment. The search module 130 comprises a search query parser 210, a query execution module 220, a search result ranking module 230, a search logger 260, a feature extraction module 240, a feature weight determination module 250, a search logs store 270, and the object store 160. Other embodiments may include more or fewer modules. Functionality indicated herein as being performed by a particular module may be performed by other modules.

The object store 160 stores objects representing entities associated with an enterprise. An enterprise may be an organization, a business, a company, a club, or a social group. An object may have an object type associated with a type of entity described by the object. Examples of object type include an account, a contact, a lead, an opportunity, and so on. It should be understood that the word “entity” may also be used interchangeably herein with “object”.

An object may represent an account representing a business partner or potential business partner (e.g. a client, vendor, distributor, etc.) of a user, and may include attributes describing a company, subsidiaries, or contacts at the company. As another example, an object may represent a project that a user is working on, such as an opportunity (e.g. a possible sale) with an existing partner, or a project that the user is trying to get. An object may represent an account representing a user or another entity associated with the enterprise. For example, an account may represent a customer of the first enterprise. An object may represent a user of the online system.

In an embodiment, the object store 160 stores an object as one or more records in a database. An object has data fields that are defined by the structure of the object (e.g. fields of certain data types and purposes). For example, an object representing an entity may store information describing the potential customer, a status of the opportunity indicating a stage of interaction with the customer, and so on. An object may represent a case that represents an interaction with a customer. For example, if a customer interacts with a user associated with the online system to provide feedback, complaint, or comments associated with a business, the interaction is recorded as a case object. The case object may include attributes such as a date of interaction, information identifying the user initiating the interaction, description of the interaction, and status of the interaction indicating whether the case is newly opened, resolved, or in progress.

The object store 160 may be implemented as a relational database storing one or more tables. Each table contains one or more data categories logically arranged as columns or fields. Each row or record of a table contains an instance of data for each category defined by the fields. For example, an object store 160 may include a table that describes a customer with fields for basic contact information such as name, address, phone number, fax number, etc. Another table might describe a purchase order, including fields for information such as customer, product, sale price, date, etc.

An object may include links or references to other objects. For example an opportunity object may include links to contact objects and account objects, an account object may include links to contact objects and so on. An object may have outgoing links that allow the object to refer to other objects as well as incoming links that allow other objects to refer to the object.

The search query parser 210 parses various components of a search query. The search query parser 210 checks if the search query conforms to a predefined syntax. The search query parser builds a data structure representing information specified in the search query. For example, the search query parser 210 may build a parse tree structure based on the syntax of the search query. The data structure provides access to various components of the search query to other modules of the online system 100.

The query execution module 220 executes the search query to determine the search results based on the search query. The search results determined represent the objects stored in the object store 160 that satisfy the search criteria specified in the search query. Accordingly, the query execution module 220 develops a query plan for executing a search query. The query execution module 220 executes the query plan to determine the search results that satisfy the search criteria specified in the search query. As an example, a search query may request all objects of a particular object type that include certain search terms. The query execution module 220 identifies objects of the specified object type that include the search terms as specified in the search criteria of the search query.

The search result ranking module 230 ranks search results determined by the query execution module 220 for a given search query. The search result ranking module 230 invokes the feature extraction module 240 to extract features of objects associated with search results. The feature extraction module 240 extracts features of objects from a given set of objects and provides the extracted features to the search result ranking module 230.

In an embodiment, the feature extraction module 240 represents a feature using a name and a value. The features describing the objects may depend on the type of object. Some features may be independent of the type of the object and apply to all types of objects. Examples of features extracted by the feature extraction module 240 include a time of the last modification of an object or the age of the last modification determined based of the length of time interval between the present time and the last time of modification. The search result ranking module 230 ranks recently modified objects higher than objects modified long time ago.

Other examples of a feature extracted by the feature extraction module 240 include a time of the last activity associated with an object or the age of the last activity associated with the object as determined based of the length of time interval between the present time and the time of the last activity associated with the object. An activity associated with an object may be a modification to the object, an access operation performed on the object, a link created to the object from another object, and so on. The search result ranking module 230 ranks objects with recent activity higher than objects with no activity in the recent past. Another example of a feature extracted by the feature extraction module 240 is a rate of activity associated with an object. The rate of activity may be measured based on a number of activity associated with the object in a unit time interval as determined by normalizing activities over a time period. The search result ranking module 230 ranks objects with high rate of activity higher than objects with low rate of activity.

Another example of a feature extracted by the feature extraction module 240 is measure of the number of links associated with the object. The number of links associated with the object nay include the number of links from the object to other objects and number of links from other objects to this object. The search result ranking module 230 ranks objects associated with higher number of links higher than an object associated with fewer links. For example, a business account associated with a large number of links, for example, contacts may be ranked higher by the search result ranking module 230 compared to another account with very few contacts.

The feature extraction module 240 extracts object type specific features from certain objects. For example, if an object represents an opportunity, the feature extraction module 240 extracts a feature indicating whether the opportunity is closed or a feature indicating an estimate of time when the opportunity is expected to close. As another example, if an object represents a case, the feature extraction module 240 extracts features describing the status of the case, status of the case indicating whether the case is a closed case, an open case, an escalated case, and so on.

The search result ranking module 230 determines a score for each search result based on the features associated with the search results. The search result ranking module 230 weighs each feature based on a set of feature weights received from the feature weight determination module 250. The search result ranking module 230 determines the score for a search result as a weighted aggregate value based on the features. In an embodiment, the search result ranking module 230 associates each feature value with a feature score. The search result ranking module 230 weighs each feature by the corresponding feature weight, for example, by multiplying the feature score with the weight. The search result ranking module 230 aggregates the weighted feature scores to determine a score for the search result. The search result ranking module 230 ranks the search results based on the scores of the search results, for example, by ordering them in decreasing order of the score if a high score indicates high likelihood of a user being interested in the search result.

The search logger 260 stores information describing search queries processed by the online system 100 in search logs store 270. The search logger 260 stores the search query received by the online system 100 as well as information describing the search results identified in response to the search query. The search logger 260 also stores information identifying accessed search results. An accessed search results represent search results for which the online system receives a request for additional information responsive to providing the search results to a requestor. For example, the search results may be presented to the user via the client device 120 such that each search result displays a link providing access to the object represented by the search result. Accordingly, a result is an accessed result if the user clicks on the link presented with the result.

In an embodiment, the search logs store 270 stores the information in a file, for example, as a tuple comprising values separated by a separator token such as a comma. In another embodiment, the search logs store 270 is a relational database that stores information describing searches as tables or relations. The search logs store 270 may include references to objects stored in the object store 160. For example, each search result may identify an object stored in the object store 160.

The feature weight determination module 250 determines feature weights for various features used for ranking search results so as to improve the likelihood that search results are presented to users in an order in which the users are likely to be interested in. Accordingly, the search results are presented in an order in which the users are likely to interact with the search results. A user may interact with a search result to retrieve more information describing the search results. In an embodiment, the feature weight determination module 250 iteratively modifies the feature weights are analyzes the effect of the modified feature weights on ranking of search results for past search requests.

In an embodiment, the feature weight determination module 250 identifies a set of feature weights that optimizes an aggregate accessed results rank. The aggregate accessed results rank is determined by re-ranking search results of a plurality of past searches and determining how the ranks of the accessed results are changed. The feature weight determination module 250 aggregates the ranks of accessed search results to determine the aggregate accessed results rank. The feature weight determination module 250 selects the set of feature weights that optimizes the aggregate accessed results rank for a plurality of past search requests. The aggregate accessed results rank may be an average click rank or a reciprocal mean reciprocal rank.

### Overall Process

The processes associated with searches performed by online system 100 are described herein. The steps described herein for each process can be performed in an order different from those described herein. Furthermore, the steps may be performed by different modules than those described herein.

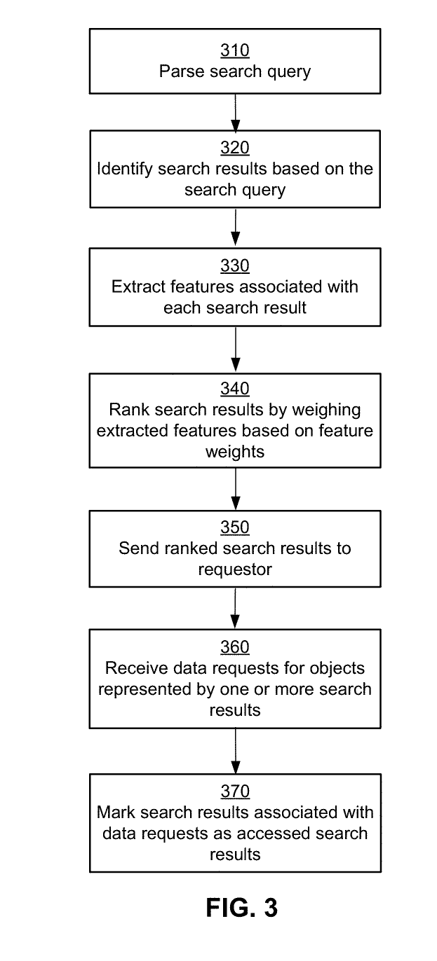

FIG. 3 shows the process of executing searches, in accordance with an embodiment. The online system 100 receives a search query and processes it. The search query may be received from a client application 120 executing on a client device 110 via the network 150. In some embodiments, the search query may be received from an external system, for example, another online system via a web service interface provided by the online system 100.

The search query comprises a search criteria. The search criteria may include one or more search terms. The search criteria may specify an expression comprising boolean and/or logical operators. In embodiments, in which the online system 100 is a multi-tenant system, the search module 130, each search query is associated with a particular tenant representing a customer of the multi-tenant system. The search module 130 performs the search within the data of the tenant associated with the search query.

The search query parser 210 parses 310 the search query. The search query parser 210 builds a data structure storing information specified in the search query. The various modules of the online system access the information of the search query using the data structure built by the search query parser 210.

The query execution module 220 identifies the search results based on the search query. The query execution module 220 identifies objects of the object store 160 that satisfy the search criteria specified in the search query. The query execution module 220 provides the search results to the search result ranking module 230 for ranking.

The search result ranking module 230 ranks the search results based on the features of the search results. The feature extraction module 240 extracts 330 various features of the search results. The features may represent various aspects of the objects represented by the search results, for example, the last modification time of the object, the last activity associated with the object, and so on. The search result ranking module 230 ranks 340 the search results by weighing the extracted features for each results based on certain feature weights as determined by the feature weight determination module 250.

The query execution module 220 receives the ranked search results from the search result ranking module 230 and provides the ranked search results to the client device 110 that sent the search query. The search logger 260 logs information describing the search query and the search results in the search log store 270. In an embodiment, the client application 120 executing on the client device presents the search results via a user interface to the user. The search results may provide information identifying the various objects represented by each search result. The search results may also specify some additional information describing each search result, for example, a snippet of text describing the object.

The client application 120 may further receive request for additional information describing a search result. In an embodiment, the client application 120 provides a link, for example, for each search result, the client application 120 may provide a uniform resource locator (URL) identifying an object represented by a search result. The user may click on the link to request more information describing the object represented by the search result. Accordingly, the online system 100 receives 360 data requests for objects represented by one or more search results.

The search logger 260 marks 370 the search results associated with subsequent data requests as accessed search results. The accessed search results represent search results for which the user expressed additional interest. The search logger 260 logs information describing the data requests associated with the search results in the search log store 270. The search logger 260 identifies the search query and the search result associated with each data request.

The feature weight determination module 250 determines the feature weights used by the search result ranking module 230. In an embodiment, the online system starts with a default value for the feature weights and then adjusts the feature weights over time. For example, the feature weight determination module 250 may initialize feature weights to an arbitrary value, for example, one. Alternatively, the feature weight determination module 250 may receive the initial feature weights from a user, for example, an expert.

Subsequently, the feature weight determination module 250 adjusts the feature weights based on historical data describing past searches as stored in the search logs store 270. The feature weight determination module 250 may adjust the feature weights periodically, for example, once every few months, or every few weeks. The adjusted feature weights are applied to subsequent search queries received by the online system.

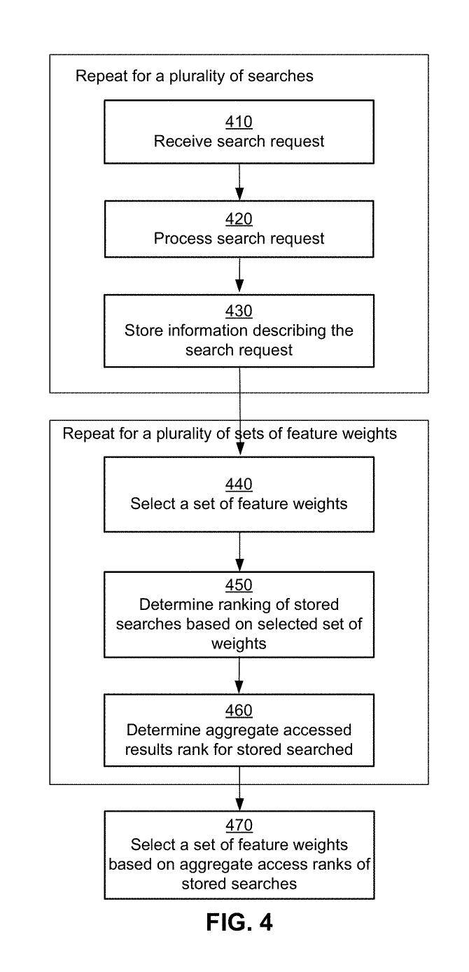

FIG. 4 shows the process of determining feature weights for ranking search results, in accordance with an embodiment. The online system 100 stores information describing searches performed by the online system over time and uses the stored information to adjust feature weights for future search requests. Accordingly, the online system 100 performs the following steps 410, 420, and 430 repeatedly. The search module 130 receives 410 a search request. The search module 130 processes 420 the search result, for example, as described in connection with the process illustrated in FIG. 3. The search module 130 stores information describing the search request, for example, in the search logs store 270. These steps are repeated over time resulting in information describing a large number of requests being stored in the search logs store 270. The online system 100 uses the stored information describing search results for determining feature weights for processing subsequent search queries.

The feature weight determination module 250 determines how the stored searches would have performed if the search results were ranked based on different feature weights. The feature weight determination module 250 determines if a particular combination of feature weights would have improved the performance of stored queries. The feature weight determination module 250 selects a set of weights based on the analysis for use in subsequent searches.

The feature weight determination module 250 performs the steps 440, 450, and 460 repeatedly for different sets of feature weights. The feature weight determination module 250 may analyze a plurality of sets of feature weights obtained by modifying the weight of a single feature. Accordingly, the feature weight determination module 250 finds an optimal set of feature weights in a one dimensional space comprising sets of feature weights obtained by changing a single feature. Alternatively, the feature weight determination module 250 may analyze a plurality of sets of feature weights obtained by modifying weights of a plurality of features. Accordingly, the feature weight determination module 250 finds an optimal set of feature weights in an N-dimensional space comprising sets of feature weights obtained by changing N features.

For each selected set of feature weights, the feature weight determination module 250 determines 450 ranking of stored searches based on the selected set of weights. Accordingly, for each stored the feature weight determination module 250 retrieves a stored search and corresponding search results. The feature weight determination module 250 determines the ranking of the search results based on the selected set of feature weights. The feature weight determination module 250 identifies the search results that were accessed by the user for additional data describing the objects represented by the search results. The feature weight determination module 250 determines 460 an aggregate accessed results rank for the set of feature weights by aggregating the ranks of the accessed search results over a plurality of stored searches.

Accordingly, the feature weight determination module 250 determines aggregate accessed results ranks for a plurality of sets of feature weights. The feature weight determination module 250 selects 470 a set of feature weights from the plurality of sets of feature weights based on the aggregate accessed results ranks for the sets of feature weights. For example, the feature weight determination module 250 may select the set of feature weights from the plurality of sets of feature weights that results in the best aggregate access results ranks amongst all the sets of feature weights. The best aggregate accessed results rank indicates that the search results ranked based on that particular feature weights showed the accessed results at the top of the list of search results.

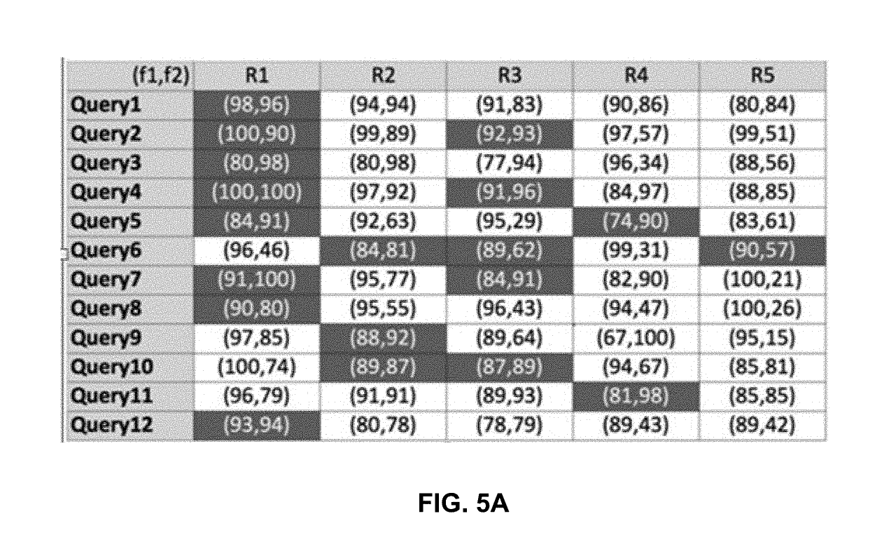

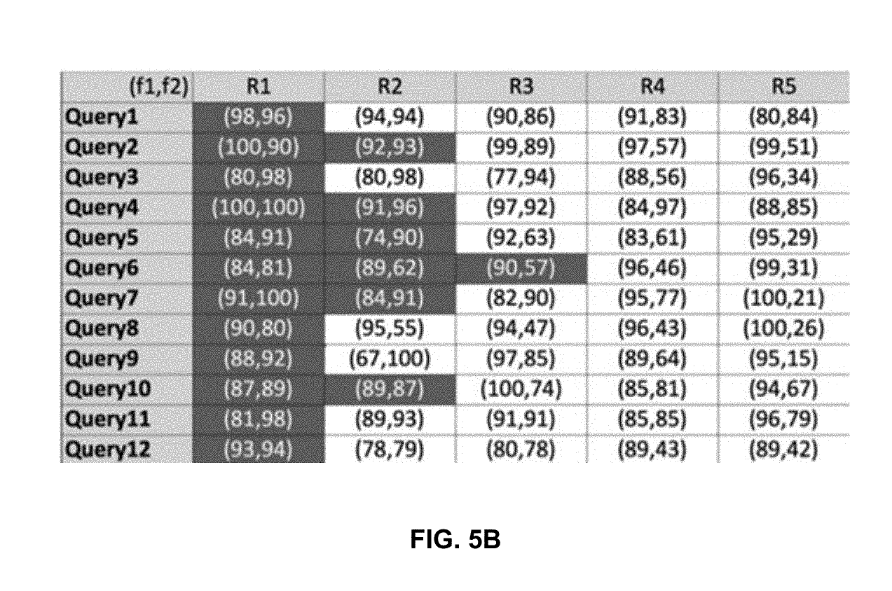

FIG. 5A and 5B illustrate how ranking of search results may be improved by modifying feature weights, in accordance with an embodiment. FIG. 5A shows a set of example search requests processed by the online system 100. The queries processed are identified as Query1, Query2, Query3, and so on. The search results returned are ranked as R1, R2, R3, and so on, where R1 represents the search result ranked 1, R2 represents the search result ranked 2, and so on. Each cell represents a search result. Each cell displays a pair of values representing a pair of features (f1, f2) for that particular search result. The shaded cells represent search results that were marked as accessed results. These search results correspond to requests from additional data of the object represented by the search result. The search results are ranked based on a first set of weights.

FIG. 5B shows the same queries and search results as those shown in FIG. 5A bur ranked based on a second set of feature weights. Accordingly, the search results are re-ranked. The search results shown in FIG. 5B indicate that the accessed search results are closer to the top of the ranked search results compared to the results shown in FIG. 5A. Accordingly, the second set of weights as illustrated in FIG. 5B results in ranking of search results such that accessed results are ranked higher than the ranking of results illustrated in FIG. 5A. Accordingly, the feature weight determination module 250 would prefer the second set of weights compared to the first set of weights.

In an embodiment, the online system 100 determines aggregate accessed results ranks for a plurality of sets of weights. The online system 100 obtains the plurality of sets of weights by modifying weights of a subset of features. The online system 100 performs a curve fitting technique to identify a curve that plots the aggregate accessed results ranks against the weights of the subset of features. For example, the curve is a one dimensional curve if the subset of features comprises a single features, the curve is a two dimensional surface if the subset of features comprises two features, and so on.

The online system 100 identifies the minima of the curve based on numerical techniques. In one embodiment, the feature weight determination module 250 calculates a derivative of the curve and finds a local minimum value based on the derivative. In other embodiments, the feature weight determination module 250 identifies values of the curve for various points and compares the values to determine the minima. The feature weight determination module 250 identifies global minima rather than local minima. The feature weight determination module 250 uses the position of the minima to determine the feature weights for the subset of features. In some embodiments, a visual representation of the curve or the surface is presented to a user via a client device. The user provides feature values that represent the minima based on the visual representation of the curve or the surface.

In an embodiment, the feature weight determination module 250 determines a set of feature weights that optimizes the aggregate accessed results ranks for each object type separately. Accordingly, a first set of feature weights is determined that optimizes the aggregate accessed results ranks for a first object type, a second set of feature weights is determined that optimizes the aggregate accessed results ranks for a second object type, and so on. For example, the first set of feature weights may be for object types representing accounts, and the second set of feature weights may be for object types representing opportunities.

In an embodiment, the online system is a multi-tenant system and the feature weight determination module 250 determines a set of feature weights that optimizes the aggregate accessed results ranks for each tenant separately. Accordingly, a first set of feature weights is determined that optimizes the aggregate accessed results ranks for a tenant, a second set of feature weights is determined that optimizes the aggregate accessed results ranks for a second tenant, and so on. For example, the first set of feature weights may be for a tenant representing a first customer of the multi-tenant system, and the second set of feature weights may be for tenant representing a second customer of the multi-tenant system.

### Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the Figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative structural and functional designs for a system and a process for displaying charts using a distortion region through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

We claim:

1. A computer implemented method for determining feature weights for ranking search results, the method comprising:
storing data comprising a plurality of objects, each object representing an entity associated with an enterprise;
receiving a first set of feature weights, each feature weight associated with a feature describing objects represented by search results, the feature weights used for ranking search results based on search queries;
storing information describing a plurality of search queries, the stored information comprising, for each stored search query: a set of search results returned in response to the search query, wherein one or more search results are marked as accessed search results responsive to receiving a data access request for an object represented by the search result;
determining a first aggregate accessed results rank for the plurality of stored searches, the first aggregate accessed results rank obtained by aggregating ranks of accessed results for the stored searches, the search results of the stored searches ranked based on the first set of feature weights;
determining a second set of feature weights;
for each of the plurality of stored queries, determining a modified ranking by weighing features of the search results using the second set of feature weights
determining a second aggregate accessed results rank for the plurality of stored searches, the second aggregate rank score obtained by aggregating ranks of accessed search results for the stored searches, the search results of the stored searches ranked based on the second set of feature weights;
determining whether the second aggregate accessed results rank is indicative of improved ranks for accessed results compared to the first aggregate accessed results rank;
responsive to determining that the second aggregate accessed results rank is indicative of improved ranks for the accessed results compared to the first aggregate accessed results rank, using the second set of feature weights for ranking search results of subsequent search requests.

2. The method of claim 1, wherein storing information describing each search query comprises:
receiving the search query from a requestor, the search query specifying a search criteria for filtering objects from the plurality of stored objects;
determining a set of search results based on the search query, each search result identifying an object matching the search criteria of the search query;
extracting features associated with each search result;
determining a score for each search result by weighing features associated with the search result based on the first set of feature weights;
ranking the search results based on the determined score for each search result;
returning the ranked search results to the requestor;
receiving one or more data requests, each data request requesting information describing an object identified by a search result;
responsive to receiving a data request for a search result, marking the search result as an accessed search result; and
storing information describing the search query and the search results.

3. The method of claim 1, wherein the second set of weights are for a first entity type, further comprising, determining a third set of weights for a second entity type.

4. The method of claim 1, further comprising:
storing information for a plurality of enterprises, wherein the second set of weights are for a first enterprise, further comprising, determining a third set of weights for a second enterprise.

5. The method of claim 1, wherein the features comprise a measure of age of last modification performed on the object.

6. The method of claim 1, wherein the features comprise a measure of an age of the last activity associated with the object.

7. The method of claim 1, wherein the features comprise a number of links from the object to other objects and from other objects to the object.

8. The method of claim 1, wherein an object represents an account associated with the enterprise, wherein the features associated with the entity comprise an activity associated with the account.

9. The method of claim 1, wherein an entity represents an account associated with the enterprise, wherein the features associated with the entity comprise an activity associated with the account.

10. The method of claim 1, wherein an object represents an opportunity associated with the enterprise, wherein the features associated with the object comprise one or more of:
information indicating whether the opportunity is closed or a score indicative of when the opportunity is expected to close.

11. The method of claim 1, wherein an object represents a case associated with the enterprise, wherein the features associated with the object comprise one or more of:
information indicating whether the case is an escalated case.

12. A computer readable non-transitory storage medium storing instructions for:
storing data comprising a plurality of objects, each object representing an entity associated with an enterprise;
receiving a first set of feature weights, each feature weight associated with a feature describing objects represented by search results, the feature weights used for ranking search results based on search queries;
storing information describing a plurality of search queries, the stored information comprising, for each stored search query: a set of search results returned in response to the search query, wherein one or more search results are marked as accessed search results responsive to receiving a data access request for an object represented by the search result;
determining a first aggregate accessed results rank for the plurality of stored searches, the first aggregate accessed results rank obtained by aggregating ranks of accessed results for the stored searches, the search results of the stored searches ranked based on the first set of feature weights;
determining a second set of feature weights;
for each of the plurality of stored queries, determining a modified ranking by weighing features of the search results using the second set of feature weights
determining a second aggregate accessed results rank for the plurality of stored searches, the second aggregate rank score obtained by aggregating ranks of accessed search results for the stored searches, the search results of the stored searches ranked based on the second set of feature weights;
determining whether the second aggregate accessed results rank is indicative of improved ranks for accessed results compared to the first aggregate accessed results rank;
responsive to determining that the second aggregate accessed results rank is indicative of improved ranks for the accessed results compared to the first aggregate accessed results rank, using the second set of feature weights for ranking search results of subsequent search requests.

13. The computer readable non-transitory storage medium of claim 12, further storing instructions for:
receiving the search query from a requestor, the search query specifying a search criteria for filtering objects from the plurality of stored objects;
determining a set of search results based on the search query, each search result identifying an object matching the search criteria of the search query;
extracting features associated with each search result;
determining a score for each search result by weighing features associated with the search result based on the first set of feature weights;
ranking the search results based on the determined score for each search result;
returning the ranked search results to the requestor;
receiving one or more data requests, each data request requesting information describing an object identified by a search result;
responsive to receiving a data request for a search result, marking the search result as an accessed search result; and
storing information describing the search query and the search results.

14. The computer readable non-transitory storage medium of claim 12, wherein the second set of weights are for a first entity type, further comprising, determining a third set of weights for a second entity type.

15. The computer readable non-transitory storage medium of claim 12, further storing instructions for:
storing information for a plurality of enterprises, wherein the second set of weights are for a first enterprise, further comprising, determining a third set of weights for a second enterprise.

16. The computer readable non-transitory storage medium of claim 12, wherein the features comprise a measure of age of last modification performed on the object.

17. The computer readable non-transitory storage medium of claim 12, wherein the features comprise a measure of an age of the last activity associated with the object.

18. The computer readable non-transitory storage medium of claim 12, wherein the features comprise a number of links from the object to other objects and from other objects to the object.

19. A computer-implemented system comprising:
a computer processor; and
a computer readable non-transitory storage medium storing instructions thereon, the instructions when executed by a processor cause the processor to perform the steps of:
storing data comprising a plurality of objects, each object representing an entity associated with an enterprise;
receiving a first set of feature weights, each feature weight associated with a feature describing objects represented by search results, the feature weights used for ranking search results based on search queries;
storing information describing a plurality of search queries, the stored information comprising, for each stored search query: a set of search results returned in response to the search query, wherein one or more search results are marked as accessed search results responsive to receiving a data access request for an object represented by the search result;
determining a first aggregate accessed results rank for the plurality of stored searches, the first aggregate accessed results rank obtained by aggregating ranks of accessed results for the stored searches, the search results of the stored searches ranked based on the first set of feature weights;
determining a second set of feature weights;
for each of the plurality of stored queries, determining a modified ranking by weighing features of the search results using the second set of feature weights
determining a second aggregate accessed results rank for the plurality of stored searches, the second aggregate rank score obtained by aggregating ranks of accessed search results for the stored searches, the search results of the stored searches ranked based on the second set of feature weights;
determining whether the second aggregate accessed results rank is indicative of improved ranks for accessed results compared to the first aggregate accessed results rank;
responsive to determining that the second aggregate accessed results rank is indicative of improved ranks for the accessed results compared to the first aggregate accessed results rank, using the second set of feature weights for ranking search results of subsequent search requests.

20. The computer system of claim 19, wherein the computer readable non-transitory storage medium further stores instructions for:
receiving the search query from a requestor, the search query specifying a search criteria for filtering objects from the plurality of stored objects;
determining a set of search results based on the search query, each search result identifying an object matching the search criteria of the search query;
extracting features associated with each search result;
determining a score for each search result by weighing features associated with the search result based on the first set of feature weights;
ranking the search results based on the determined score for each search result;
returning the ranked search results to the requestor;
receiving one or more data requests, each data request requesting information describing an object identified by a search result;
responsive to receiving a data request for a search result, marking the search result as an accessed search result; and
storing information describing the search query and the search results.
